(19) United States
(12) Patent Application Publication
(10) Pub. No.: US 2025/0286925 A1
(43) Pub. Date: Sep. 11, 2025

(54) MOBILE DEVICE AND SELECTIVE OFFLOADING METHOD OF THE SAME

(71) Applicant: Electronics and Telecommunications Research Institute, Daejeon (KR)

(72) Inventors: Ryangsoo Kim, Daejeon (KR); Sung Chang Kim, Daejeon (KR); Geun Yong Kim, Daejeon (KR); Jaein Kim, Daejeon (KR); Chorwon Kim, Daejeon (KR); Hee Do Kim, Daejeon (KR); Ji Hyoung Ryu, Daejeon (KR); Byung-Hee Son, Daejeon (KR); Kicheoul Wang, Daejeon (KR); Hark Yoo, Daejeon (KR); Giha Yoon, Daejeon (KR)

(73) Assignee: Electronics and Telecommunications Research Institute, Daejeon (KR)

(21) Appl. No.: 19/073,849

(22) Filed: Mar. 7, 2025

(30) Foreign Application Priority Data
Mar. 7, 2024 (KR) 10-2024-0032436
Jul. 22, 2024 (KR) 10-2024-0096216

(51) Int. Cl. H04L 67/1004; H04W 28/02; H04W 28/08

(52) U.S. Cl. CPC H04L 67/1004; H04W 28/0221; H04W 28/08

(57) ABSTRACT

Provided is a mobile device according to one embodiment of the present disclosure. The mobile device includes a camera module, a communication module providing a wireless link for communication with a server, and a processor functionally connected to the camera module and the communication module, wherein the processor collects video data through the camera module, and determines whether to perform an offloading function for analyzing the video data by utilizing computing resources of the server according to a wireless link status of the communication module based on an offloading policy, and the offloading policy is determined by learning a change in video analysis performance of the mobile device and the server according to a change in the wireless link status.

### CROSS-REFERENCE TO RELATED APPLICATION

This application claims priority to and the benefit of Korean Patent Applications No. 10-2024-0032436, filed on Mar. 7, 2024, and No. 10-2024-0096216, filed on Jul. 22, 2024, the disclosure of which is incorporated herein by reference in its entirety.

### BACKGROUND

### 1. Field of the Invention

Various embodiments disclosed in this document relate to edge computing technology.

### 2. Discussion of Related Art

Recently, server-edge collaborative data analysis technology (offloading technology), in which mobile devices utilize the computing resources of high-performance edge servers to analyze data, has been used. In particular, the benefits of applying offloading technology are significant in fields that require extensive computation such as video analysis processing.

However, server-edge collaborative data analysis technology requires a stable network for data transmission and reception and is difficult to perform when network quality deteriorates.

### SUMMARY OF THE INVENTION

However, since the network quality of a mobile device in wireless communication with a server may deteriorate during movement of mobile device, it is difficult to ensure server-edge collaborative data analysis performance.

Various embodiments disclosed in this document may provide a mobile device that can selectively perform offloading based on communication link quality and a selective offloading method of the same.

According to an aspect of an embodiment, there is provided a mobile device which includes: a camera module; a communication module providing a wireless link for communication with a server; and a processor functionally connected to the camera module and the communication module, wherein the processor may collect video data through the camera module, and determine whether to perform an offloading function for analyzing the video data by utilizing computing resources of the server according to a wireless link status of the communication module based on an offloading policy. The offloading policy may be determined by learning a change in video analysis performance of the mobile device and the server according to a change in the wireless link status.

According to another aspect of an embodiment, there is provided a selective offloading method of a mobile device, which includes checking a wireless link status when collecting video data through a camera module; performing video analysis on the video data by utilizing computing resources of the mobile device or a server based on an offloading policy according to the wireless link status; and updating the offloading policy based on a correlation between video analysis performance of the mobile device and the server according to the wireless link status.

According to still another aspect of an embodiment, there is provided a mobile device which includes a memory including at least one instruction; and a processor functionally connected to the memory, wherein, when the at least one instruction is executed, the processor checks a wireless link status on a communication path with a server performing edge computing-based video analysis when video data is collected, analyzes the video data by selectively utilizing computing resources of the server or the mobile device based on an offloading policy according to the wireless link status, and updates the offloading policy by learning a change in video analysis performance for the video data according to a change in the wireless link status.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 illustrates an implementation environment of a mobile device enabling selective offloading according to one embodiment;

FIG. 2 is a structural diagram illustrating a server-edge collaboration-based video analysis framework according to one embodiment;

FIG. 3 is a block diagram illustrating a mobile device according to one embodiment;

FIG. 4 illustrates a data communication process between a mobile device and an edge server according to one embodiment;

FIG. 5 illustrates an edge computing-based data analysis performance measurement environment according to one embodiment;

FIGS. 6A, 6B, and 6C are graphs illustrating per-frame instantaneous energy consumption over time;

FIG. 7 is a graph illustrating per-frame average energy consumption results over time;

FIGS. 8A, 8B, and 8C are graphs illustrating video analysis delay time over time;

FIG. 9 is a graph illustrating the cumulative number of times that the video analysis delay time exceeds a threshold over time;

FIG. 10 is a schematic flowchart illustrating a selective offline method according to one embodiment; and

FIG. 11 is a detailed flowchart illustrating a selective offline method according to one embodiment.

In connection with the description of the drawings, the same or similar reference numerals may be used for the same or similar components.

### DETAILED DESCRIPTION OF EXEMPLARY EMBODIMENTS

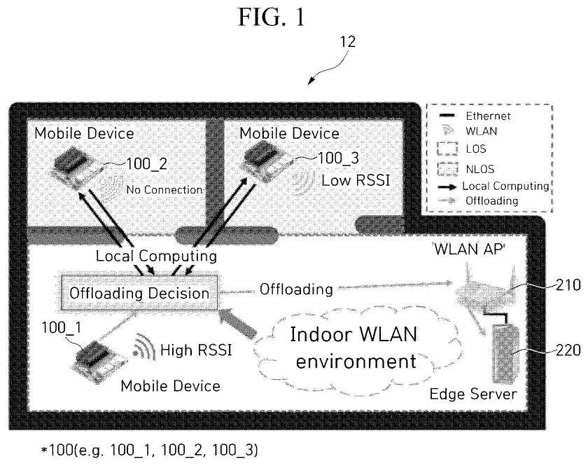

FIG. 1 illustrates an implementation environment of a mobile device enabling selective offloading according to one embodiment.

Referring to FIG. 1, an edge computing-based video analysis system 12 (server-edge collaborative data analysis system) may include an edge server 220, a base station device 210, and a plurality of mobile devices 100.

According to one embodiment, the edge server 220 may be a server located close to the mobile device 100 and capable of providing computing resources. The edge server 220 may receive video data and perform specified video analysis processing. As a result of the specified video analysis processing, the edge server 220 may provide analysis result data to the mobile device 100.

According to one embodiment, the base station device 210 may communicate data with the edge server 220 through a wired network and communicate data with the plurality of mobile devices 100 through a wireless network. The base station device 210 may include at least one device of an access point providing a wireless local area network (LAN) and a base station (BS) providing a mobile network.

According to one embodiment, the mobile device 100 may be a device having a built-in battery, such as an unmanned vehicle (e.g., a robot or a drone) or a portable terminal (e.g., a smartphone).

According to one embodiment, the mobile device 100 may collect video data and analyze the collected video data using at least one computing resource of the computing resources of the mobile device 100 or the computing resources of the edge server 220. For example, the mobile device 100 may analyze a video by collaborating with the edge server 220 by performing an offloading function. When the offloading function is performed, the mobile device 100 may transmit an analysis request for the collected video data to the edge server 220 via a wireless link and receive a video analysis result (analysis result data) from the edge server 220.

The mobile device 100 communicates with the edge server 220 via a wireless network due to its mobility. Therefore, when a wireless link status changes due to the movement of the mobile device 100, the offloading-based video analysis performance may deteriorate. In particular, in an indoor wireless link environment, a non-line-of-sight (NLOS) radio environment frequently occurs due to various obstacles and walls. In this case, the wireless link status of the mobile device 100 may be degraded momentarily, and the offloading-based video analysis performance may also be rapidly degraded.

To prevent this, the mobile device 100 according to one embodiment may perform task offloading autonomous optimization to ensure video analysis inference performance according to changes in the spatial-temporal wireless network environment. This will be described below.

According to one embodiment, the mobile device 100 may learn the change in video analysis performance according to the change in the wireless link environment. For example, the mobile device 100 may measure the wireless link status using a received signal strength indicator (RSSI) from the base station device 210 providing the wireless link. The mobile device 100 may learn the change in the video analysis performance according to the change in the measured received signal strength.

According to one embodiment, the mobile device 100 may determine an offloading policy by learning the performance change of the video analysis according to the change in the wireless link status. For example, the mobile device 100 may learn at least one of energy consumption for video analysis, video analysis delay time, or a frame rate per unit time with respect to the video data according to the change in the wireless link status. For another example, the mobile device 100 may gradually learn at least one characteristic of per-frame energy consumption and video analysis delay time, which are affected by changes in the wireless link status, based on a real-time learning algorithm, and determine an optimal offloading policy by itself. The mobile device 100 may calculate, for example, the per-frame energy consumption by dividing the energy consumption of the mobile device 100 by a frame rate per unit time. The mobile device 100 may calculate, for example, the time from the start time to the end time for video analysis as the video analysis delay time.

According to one embodiment, the mobile device 100 may determine an optimized offloading policy while gradually learning video analysis performance according to the wireless channel environment using an online learning algorithm. For example, the mobile device 100 may determine an offloading policy that minimizes the per-frame energy consumption while maintaining the video analysis delay time that is less than or equal to a threshold by learning the video analysis performance according to the wireless link status. The threshold may be, for example, the maximum delay time required for the video analysis service.

According to one embodiment, the mobile device 100 may determine whether to perform offloading for video analysis based on the current wireless link status according to the determined offloading policy.

Next, when determining to perform offloading, the mobile device 100 may request a specified analysis on the video data from the edge server 220. On the other hand, when determining not to perform offloading, the mobile device 100 may perform video analysis by itself.

According to various embodiments, the edge server 220 may further utilize the computing resources of a cloud server (not shown) in relation to complex video analysis tasks to process video analysis.

In this manner, the mobile device 100 according to one embodiment may monitor a change in the wireless link status and determine by itself whether to request a computationally intensive task from the edge server 220. Accordingly, it is possible to perform offloading to minimize the per-frame energy consumption of the mobile device 100 and maintain the video analysis delay at an acceptable level. In addition, the mobile device 100 may maintain the video analysis at a level that does not exceed the maximum delay threshold required for the video analysis service and reduce the energy consumption for video analysis of the mobile device 100, thereby increasing the operating time of the mobile device 100 on a single battery charge.

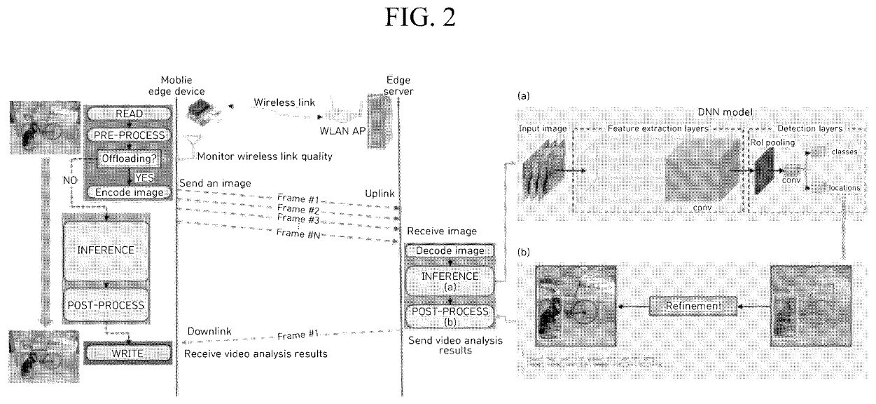

FIG. 2 is a structural diagram illustrating a server-edge collaboration-based video analysis framework according to one embodiment.

Referring to FIG. 2, an edge computing-based task offload framework aims to shorten video analysis time by using all computing resources available in the mobile device 100 and the edge server 220 under a wireless link environment. The edge computing-based task offload framework may divide a video analysis task into subtask sequences to increase the overall computing resource utilization rate and apply task-level pipeline parallelization (to distribute and process each subtask sequence in the mobile device 100 and the edge server 220). The above-described task-level pipeline parallelization may be implemented as queue-based multi-thread programming that generates multiple thread modules to execute subtasks simultaneously and places a first-in-first-out (FIFO) queue between subsequent subtasks to transfer processed output data from the previous subtask to the next subtask. Therefore, the edge computing-based task offload framework may reduce processing delay time while maintaining processing integrity for the video analysis service.

A deep learning-based video analysis service according to one embodiment may be composed of five stages: 1) input stage, 2) preprocessing stage, 3) inference stage, 4) postprocessing stage, and 5) output stage. The subtasks of the five stages may be distributed and processed in the mobile device 100 and the edge server 220 in consideration of the task time consumed according to the computing power of the mobile device 100 and the edge server 220, and the network delay time according to the amount of data transmitted between the respective subtasks. At this time, the optimized subtask placement may vary depending on the type of the video analysis service that is actually implemented.

In an edge computing-based video analysis system 12, the input stage, preprocessing stage, and output stage may be driven by the mobile device 100, and the inference stage and postprocessing stage may be driven by the edge server 220. For example, a deep neural network (DNN)-based video analysis system requires considerable computing power in a deep learning model inference stage and a result postprocessing stage. When performing an offloading function through a wireless link between the mobile device 100 and the edge server 220, the mobile device 100 may transmit video data reduced through preprocessing to the edge server 220, and the edge server 220 may filter only meaningful results from among the video analysis results and transmit the filtered data to the mobile device 100, thereby minimizing the network delay time during data transmission.

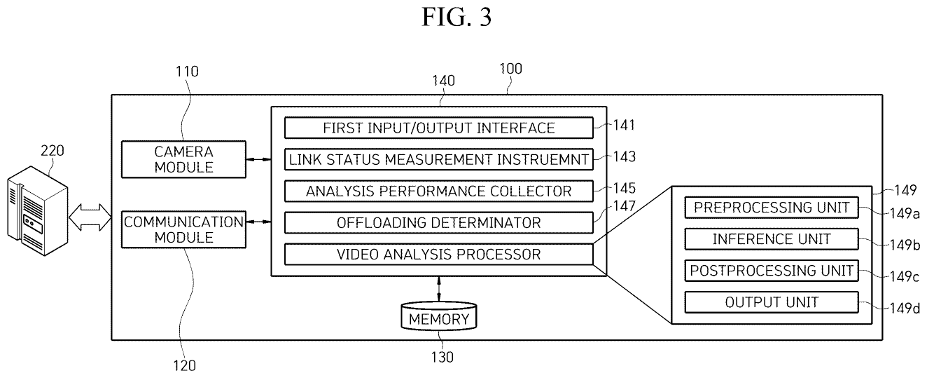

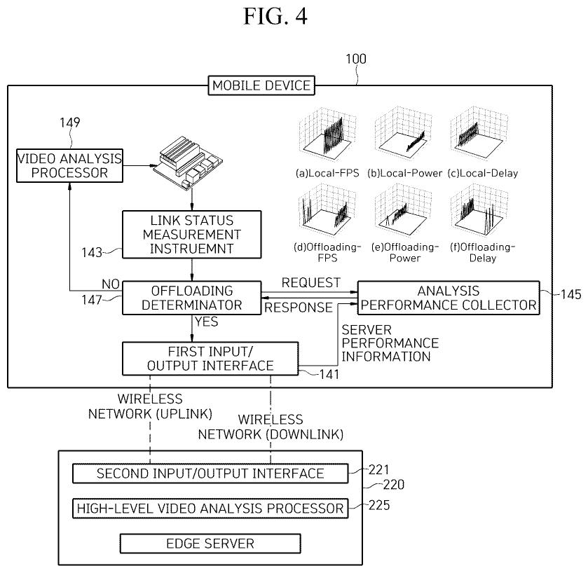

FIG. 3 is a block diagram illustrating a mobile device according to one embodiment, and FIG. 4 illustrates a data communication process between a mobile device and an edge server according to one embodiment.

Referring to FIG. 3, the mobile device 100 according to one embodiment may include a camera module 110, a communication module 120, a memory 130, and a processor 140. In one embodiment, the mobile device 100 may not include some of the above components or may further include additional components. In addition, some of the components of the mobile device 100 may be combined into a single entity, but the functions of the corresponding components before combination may be performed in the same manner even after combination. For example, the camera module 110 may be configured separately from the mobile device 100. In this case, the processor 140 may further check the wireless link status for receiving video data from the camera module 110 and determine the offloading policy based on the further checked wireless link status.

The camera module 110 may include at least one video sensor among a charge coupled device (CCD) and a metal oxide semi-conductor (MOS). The camera module 110 may capture and generate a video of the surroundings of the mobile device 100 under the control of the processor 140.

The communication module 120 may support the establishment of a communication channel or wireless communication channel between the mobile device 100 and another device (e.g., the edge server 220), and communication through the established communication channel. The communication channel may include, for example, at least one communication channel among LAN, FTTH, xDSL, Wibro, Wireless LAN, Wi-Fi, Bluetooth, ZigBee, Wi-Fi Direct (WFD), Ultrawideband (UWB), Infrared Data Association (IrDA), Bluetooth Low Energy (BLE), Near Field Communication (NFC), 3G, 4G, and 5G. The communication module 120 may perform communication using well-known communication methods such as Code Division Multiple Access (CDMA), Global System for Mobile communications (GSM), W-CDMA, TD-SCDMA, WiBro, Long Term Evolution (LTE), Evolved Packet Core (EPC), etc.

The memory 130 may include various forms of volatile memories or nonvolatile memories. For example, the memory 130 may include a read only memory (ROM) and a random access memory (RAM). In one embodiment, the memory 130 may be located inside or outside the processor 140, and may be connected to the processor 140 through various means known in the art. The memory 130 may store a variety of data used by at least one component of the mobile device 100 (e.g., the processor 140). The data may include, for example, input data or output data for software and commands related thereto. For example, the memory 130 may store at least one instruction and data for performing a selective offload function according to a wireless link condition. The memory 130 may store an offloading policy determined according to a threshold and learning of the wireless link condition.

The processor 140 may control at least one other component (e.g., a hardware or software component) of the mobile device 100 and perform various data processing or calculations. The processor 140 may include, for example, at least one of a central processing unit (CPU), a graphics processing unit (GPU), a microprocessor, an application processor, an application specific integrated circuit (ASIC), and a field programmable gate array (FPGA), and may have a plurality of cores. According to one embodiment, the processor 140 may collect video data through the camera module 110, determine an offloading policy by learning changes in video analysis performance for the video data according to the wireless link status, and determine whether to perform an offloading function that analyzes the video data through the edge server 220 according to the determined offloading policy. Depending on whether the offloading function is to be performed, the processor 140 may analyze the collected video data using the computing resources (artificial intelligence model) of the edge server 220 or the self-computing resources (self-artificial intelligence model) of the mobile device 100.

Referring to FIGS. 3 and 4, the processor 140 according to one embodiment may include a first input/output interface 141, a link status measurement instrument 143, an analysis performance collector 145, an offloading determinator 147, and a video analysis processor 149. The first input/output interface 141, the link status measurement instrument 143, the analysis performance collector 145, the offloading determinator 147, and the video analysis processor 149 may be hardware modules or software modules included in the processor 140 or executed by the processor 140.

According to one embodiment, the first input/output interface 141 may transmit a video analysis request for video data to the edge server 220 through the communication module 120 when performing offloading. The first input/output interface 141 may obtain analysis result data from the edge server 220 through the communication module 120 and transmit the obtained analysis result data (an inference result value) to an output unit 149d of the video analysis processor 149.

According to one embodiment, the link status measurement instrument 143 may measure a wireless link status formed or established by the communication module 120. For example, the link status measurement instrument 143 may check an RSSI from the base station device 210 providing the wireless link as the wireless link status.

According to one embodiment, the analysis performance collector 145 may collect the video analysis performance by the video analysis processor 149 or the edge server 220. For example, the analysis performance collector 145 may check at least one of the energy consumption, delay time, or frame rate per unit time for video analysis of the video data. The analysis performance collector 145 may check, for example, at least one of per-frame instantaneous energy consumption over time or per-frame average energy consumption over time as the energy consumption. The analysis performance collector 145 may check, for example, the time interval from when the analysis of the video data begins to when the video analysis result is obtained as the delay time. The frame rate per unit time may be, for example, frames per second (FPS) analyzed by the video analysis processor 149. The analysis performance collector 145 may calculate the per-frame energy consumption by dividing the energy consumption of the mobile device 100 by the frame rate per unit time.

According to one embodiment, the offloading determinator 147 may determine the offloading policy by learning the change in the image analysis performance for the image data according to the wireless link status. For example, the offloading determinator 147 may obtain each of an output value (e.g., a wireless link status value) of the link status measurement instrument 143 and an output value (per-frame energy consumption, delay time) of the analysis performance collector 145 as an input. The offloading determinator 147 may determine an offloading policy that can minimize the per-frame energy consumption while the per-frame energy consumption does not exceed a specified threshold.

In one embodiment, the offloading determinator 147 may learn the change in the image analysis performance according to the change in the wireless link status applying an online learning algorithm. The offloading determinator 147 may update the current offloading policy by reflecting each of the learning result.

According to one embodiment, the offloading determinator 147 may check the current wireless link status and determine whether to perform an offloading function in the checked wireless link status according to the determined offloading policy. The offloading determinator 147 may check whether performing or not performing the offloading function in the current wireless link status is advantageous to the video analysis performance.

According to one embodiment, the processor 140 may perform image analysis through the video analysis processor 149 or the edge server 220 depending on whether the offloading function is performed.

The video analysis processor 149 may include a preprocessing unit 149a, an inference unit 149b, a postprocessing unit 149c, and an output unit 149d. The preprocessing unit 149a may adjust the size of video data and normalize the video data. The inference unit 149b may perform a specified inference (e.g., object recognition) on a feature value of the video data obtained based on a deep learning model when the normalized video data is obtained. The postprocessing unit 149c may correct and improve an inference result value. The output unit 149d may store the inference result value in the memory 130 or output the inference result value through an output module (not shown).

When the offloading function is determined to be performed, the preprocessing unit 149a may reduce the video data by preprocessing the video data and transmit the preprocessed video data to the edge server 220 through the communication module 120. Next, when the edge server 220 analyzes a video for the video data and transmits analysis result data, the processor 140 may receive the analysis result data. The output unit 149d may store or output the analysis result data (inference result value).

On the other hand, when the offloading function is determined not to be performed, the preprocessing unit 149a may preprocess the video data, the inference unit 149b may perform a specified inference on the video data, and the postprocessing unit 149c may correct and improve the inference result value. The output unit 149d may store or output the corrected and improved inference result value.

Referring to FIG. 4, the edge server 220 according to one embodiment may include a second input/output interface 221 and a high-level video analysis processor 225. The second input/output interface 221 and the high-level video analysis processor 225 may be executed by at least one processor of the edge server 220 or may be a hardware module or software module included in the at least one processor.

When obtaining preprocessed video data and an analysis request for the video data, the second input/output interface 221 may transmit the video data to the high-level video analysis processor 225.

The high-level video analysis processor 225 may perform a specified inference on the video data using a high-level DNN model and postprocess the inference result value. The specified inference may include, for example, at least one of object detection, image classification, and video segmentation.

The second input/output interface 221 may transmit analysis result data including the inference result value to the mobile device 100 via a wireless link.

In this way, the mobile device 100 according to one embodiment may perform the offloading function to minimize the per-frame energy consumption and maintain the delay for video analysis at an acceptable level (less than or equal to a maximum delay threshold). Accordingly, the mobile device 100 may maintain the video analysis at a level that does not exceed the maximum delay threshold required for the video analysis service and may reduce the energy consumption for video analysis of the mobile device 100, thereby increasing the operating time of the mobile device 100 on a single battery charge.

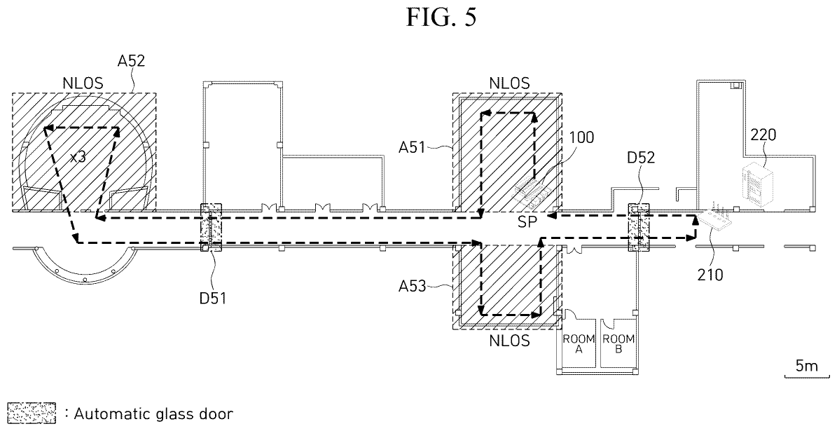

FIG. 5 illustrates an edge computing-based data analysis performance measurement environment according to one embodiment.

Referring to FIG. 5, a measurement environment may be an area where two automatic glass doors D51 and D52 and three NLOS areas A51, A52, and A53 exist. The mobile device 100 communicates with the base station device 210 through a wireless network, and the base station device 210 (e.g., WLAN AP) is connected to the edge server 220 through a wired network.

As indicated by the dotted arrow, the mobile device 100 performs image analysis while moving around the first NLOS area A51, through the first automatic glass door D51, and rotating three times around the second NLOS area A52 from a starting point SP, and then moving through the first automatic glass door D51, around the third NLOS area A53, through the second automatic glass door D52, around the area near the edge server 220, and through the second automatic glass door D52, and returning to the starting point Start. Since a non-line-of-sight environment occurs in the first to third NLOS areas A51, A52, and A53 due to obstacles and walls, the wireless link quality of the mobile device 100 may deteriorate rapidly. In addition, the automatic glass doors D51 and D52 may also deteriorate the wireless link quality.

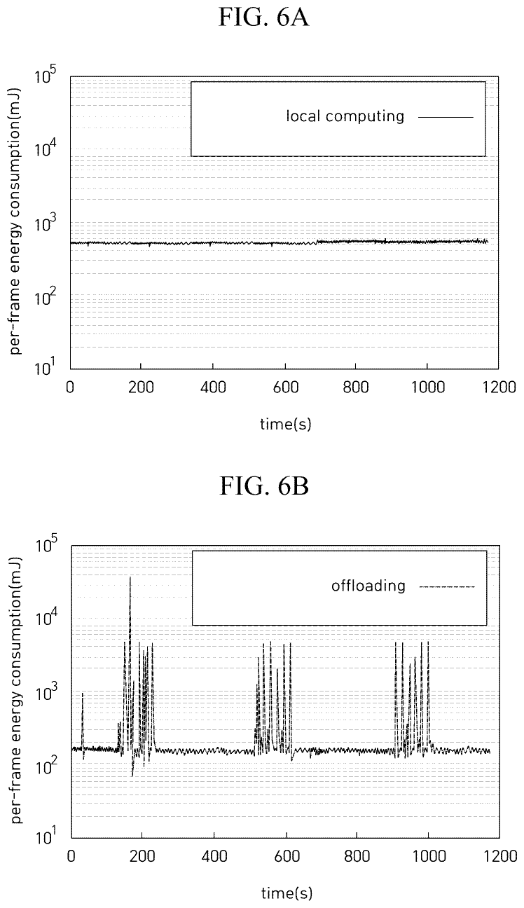

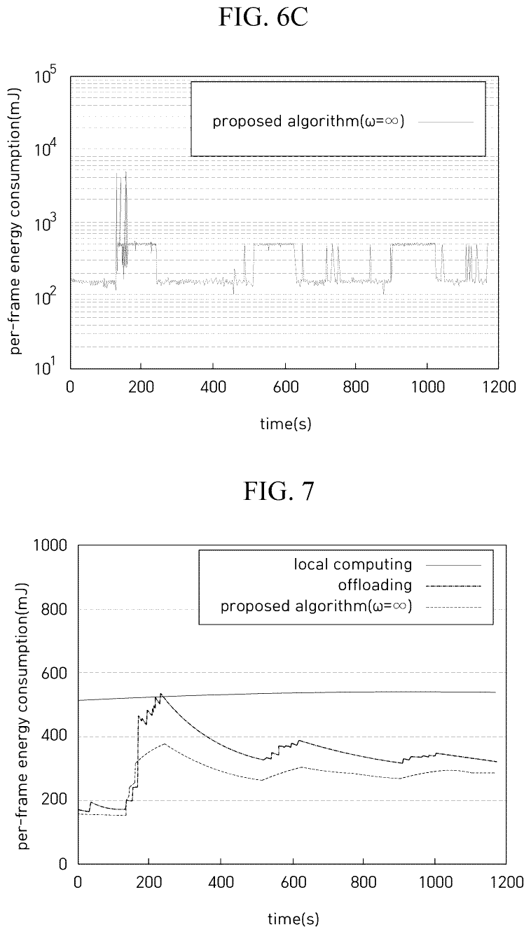

Hereinafter, referring to FIGS. 6 to 9, the video analysis performance of the mobile device 100 in the measurement environment of FIG. 5 when offloading is performed, offloading is not performed, and offloading is selectively performed will be compared. In FIGS. 6 to 9, <Case 1> local computing graph is video analysis performance by the mobile device 100 when offloading is not performed, <Case 2> offloading graph is video analysis performance through the edge server 220 when offloading is continuously performed, and <Case 3> proposed algorithm graph is video analysis performance when offloading is selectively performed according to the offloading policy.

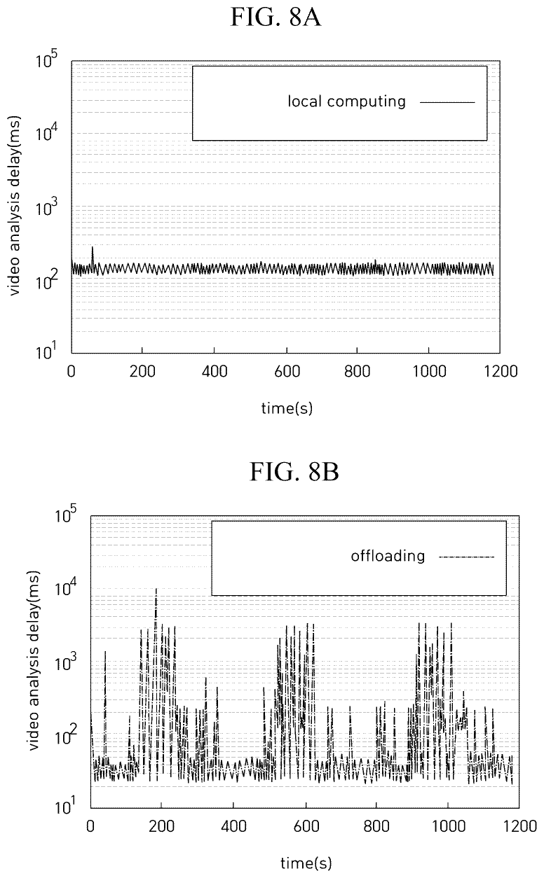

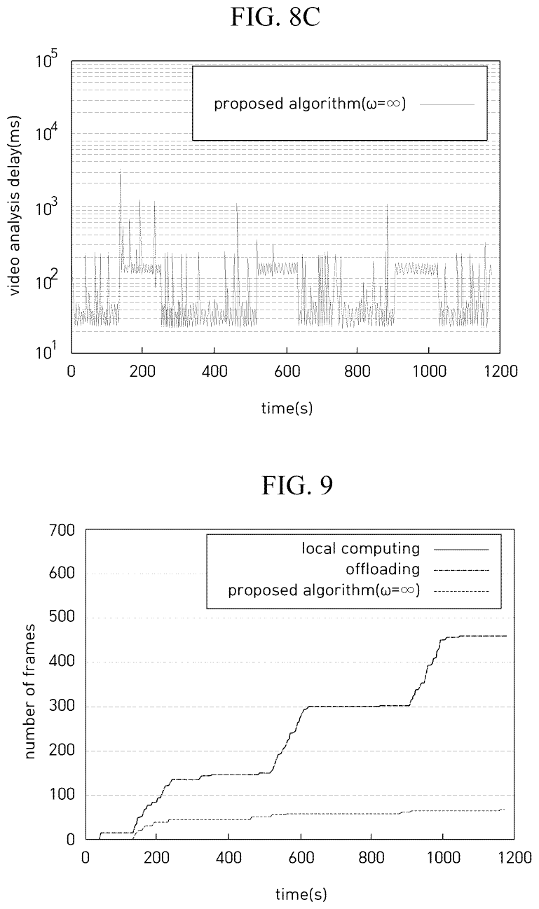

FIG. 6 is a graph illustrating per-frame instantaneous energy consumption over time, and FIG. 7 is a graph illustrating per-frame average energy consumption results over time. FIG. 8 is a graph illustrating video analysis delay time over time, and FIG. 9 is a graph illustrating the cumulative number of times that the video analysis delay time exceeds a threshold over time.

Per-frame instantaneous energy consumption of FIG. 6A to 6C may be a result value obtained by dividing power consumption (J/sec) of the mobile device 100 checked at each measurement point by a frame rate per unit time (frames/sec). Per-frame average energy consumption of FIG. 7 may be an average value of the per-frame instantaneous energy consumption checked at each measurement point.

First, the per-frame energy consumption of the three cases is compared with reference to FIGS. 6 and 7.

Referring to FIG. 6A, in <Case 1> (local computing), since video analysis is performed only on the mobile device 100, the per-frame instantaneous energy consumption is constant at approximately 400 mJ. In <Case 2> of FIG. 6B (offloading), since video analysis is performed only on the edge server 220 through offloading, the per-frame instantaneous energy consumption decreases as the video analysis is not performed when the link condition is superior, but the per-frame instantaneous energy consumption increases rapidly as extensive energy is consumed for data communication when the link condition deteriorates.

However, in <Case 3> if FIG. 6C (proposed algorithm), since the mobile device 100 according to one embodiment performs the offloading function according to the determined offloading policy, it can be confirmed that the per-frame instantaneous energy consumption is generally less than the case where the corresponding video is analyzed only on the mobile device 100 except before learning or during initial learning. In addition, as shown in FIG. 7, it can be confirmed that the per-frame average energy consumption is also lower in <Case 3> than in <Case 1> or <Case 2>.

Next, the video analysis delay of the three cases will be compared with reference to FIGS. 8 and 9.

As shown in FIG. 8A, in <Case 1>, since there is little surrounding video when the mobile device 100 analyzes the corresponding video by itself, the image analysis delay is constant at about 100 ms. In <Case 2> of FIG. 8B, since video analysis is performed on the edge server 220 using high-performance computing resources, the processing time may vary depending on the communication speed. Therefore, when the link condition is superior, the video analysis delay is less than in <Case 1>, but when the link condition deteriorates, the video analysis delay also increases rapidly as the data communication speed decreases.

However, in <Case 3> of FIG. 8C, since the mobile device 100 according to one embodiment performs the offloading function according to the determined offloading policy, it can be confirmed that the video analysis delay is generally less than when the corresponding video is analyzed only on the mobile device 100 except before learning or during the initial learning. In addition, as shown in FIG. 9, the cumulative number of times the video analysis delay time exceeds a threshold also continuously increases in <Case 2>, but it can be confirmed that the cumulative number of times the video analysis delay time exceeds the threshold hardly increases in <Case 3> as the offloading policy is optimized through learning repetition.

In this way, the mobile device 100 according to one embodiment may reduce the video analysis delay time and improve the per-frame energy consumption according to the selective offloading policy determined by learning the video analysis performance according to the communication link status.

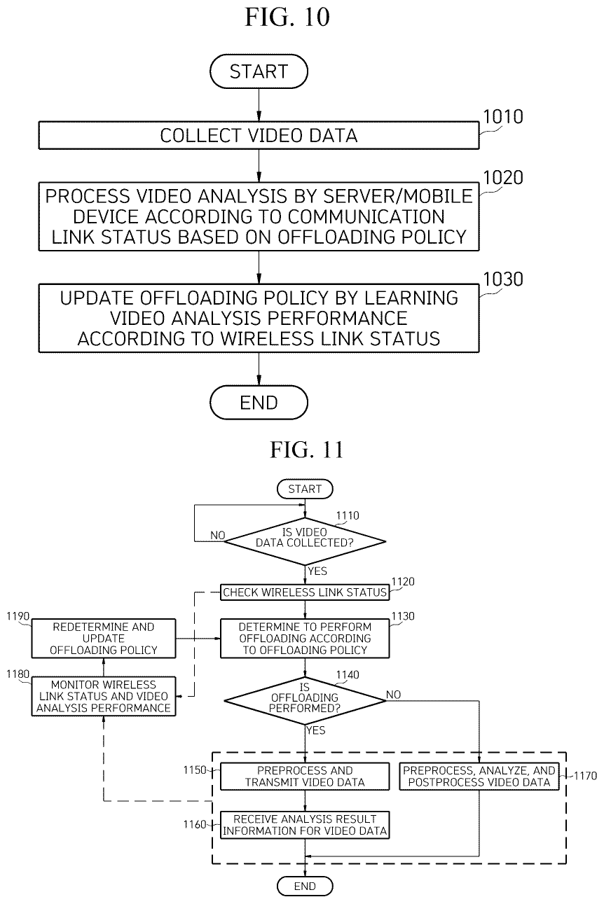

FIG. 10 is a schematic flowchart illustrating a selective offline method according to one embodiment.

Referring to FIG. 10, in operation 1010, the mobile device 100 may collect video data through the camera module 110.

In operation 1020, the mobile device 100 may perform video analysis on the video data by utilizing the computing resources of the mobile device 100 or the edge server 220 according to an offloading policy.

In operation 1030, the mobile device 100 may update the offloading policy by learning a change in video analysis performance according to a change in a wireless link status on a communication path with the edge server 220.

FIG. 11 is a detailed flowchart illustrating a selective offline method according to one embodiment.

Referring to FIG. 11, in operation 1110, the mobile device 100 may collect video data through the camera module 110.

In operation 1120, the mobile device 100 may check a wireless link status on a communication path with the edge server 220.

In operation 1130, the mobile device 100 may determine whether to perform an offloading function according to the wireless link status based on an offloading policy.

In operation 1140, when it is checked that the offloading function is performed, the mobile device 100 may preprocess video data and transmit the preprocessed video data to the edge server 220 in operation 1150. Next, the edge server 220 may perform a specified inference based on the preprocessed video data and generate and transmit inference result data by postprocessing the inference result. The edge server 220 may generate analysis result data including only the part related to the inference result of the preprocessed video data.

In operation 1160, the mobile device 100 may receive the analysis result data transmitted by the edge server 220. The mobile device 100 may store or output the analysis result data.

On the other hand, when it is checked in operation 1140 that the offloading function is not performed, the mobile device 100 may preprocess, analyze, and postprocess the video data to generate the inference result data in operation 1170.

In operation 1180, the mobile device 100 may measure the wireless link status and the video analysis performance during the process of transmitting and receiving the video data and the analysis result data of the video data. Additionally, the mobile device 100 may also measure the video analysis performance of the video analysis processor 149 thereof.

In operation 1190, the mobile device 100 may update the offloading policy based on the correlation between the video analysis performance according to the change in the wireless link status. Next, the mobile device 100 may determine whether to perform the offloading function according to the updated offloading policy.

According to various embodiments disclosed in this document, selective offloading can be performed based on communication link quality. In addition, various effects directly or indirectly identified through this document can be provided.

It should be understood that various embodiments of the present document and terms used herein are not intended to limit the technical features described in the present document to specific embodiments and include various modifications, equivalents, or alternatives of the corresponding embodiment. With regard to description of drawings, similar or related components may be marked by similar reference marks/numerals. A singular form of a noun corresponding to an item may include one or more of items unless the relevant context clearly indicates otherwise. In the present invention, phrases such as “A or B,” “at least one ofA and B,” “at least one of A or B,” “A, B, or C,” “at least one of A, B, and C,” and “at least one of A, B, or C” may include any one of the items listed together in a corresponding one of the phrases or all possible combinations thereof. Such terms as “first” and “second” or “1^{st}” and “2^{nd}” may be used to simply distinguish a corresponding component from another corresponding component and does not limit the components in other aspects (for example, importance or order). When it is mentioned that a first component is “coupled” or “connected” to a second component together with or without the terms such as “functionally” or “communicatively,” this means that the first component may be connected to the second component directly (e.g., by wire), wireless, or through a third component.

The term “module” used in herein may include a unit implemented in hardware, software, or firmware, and may be used interchangeably with the terms such as logic, a logic block, a component, or a circuit. The module may be an integrally formed component or a minimum unit or a part of the component performing one or more functions. For example, according to the embodiment, the module may be implemented in the form of an ASIC.

Various embodiments of the present document may be implemented as software (e.g., a program) including one or more instructions stored in a storage medium (e.g., an internal memory or an external memory) (e.g., the memory 130) that may be read by a machine (e.g., the mobile device). For example, a processor (e.g., the processor 140) of the apparatus (e.g., the mobile device 100) may call and execute at least one of the one or more instructions stored from the storage medium. This enables at least one function to be performed according to the at least one called instruction. The one or more instructions may include a code that is made by a compiler or a code that may be executed by an interpreter. A device-readable storage medium may be provided in the form of a non-transitory storage medium. Here, the term “non-transitory” merely means that the storage medium is a tangible device and does not include a signal (e.g., an electromagnetic wave), and this term does not distinguish a case in which data is semi-permanently stored on a storage medium and a case in which data is stored temporarily from each other.

According to the embodiment, a method according to various embodiments disclosed in the present document may be provided and included in a computer program product. The computer program product may be traded between a seller and a buyer as a product. The computer program product may be distributed in the form of the device-readable storage medium (e.g., a compact disk read only memory (CD-ROM)) or distributed (e.g., downloaded or uploaded) in an on-line manner directly through an application store (e.g., Play Store™) or between two user devices (e.g., smartphones). In the case of on-line distribution, at least part of the computer program product may be at least temporarily stored in the device-readable storage medium such as the memory of a manufacturer's server, an application store's server, or a relay server or may be generated temporarily.

The components according to various embodiments of the present document may be implemented in the form of software or hardware such as a digital signal processor (DSP), an FPGA, or an ASIC and may perform predetermined roles. The “components” are not limited to software or hardware, and each of the components may be configured in an addressable storage medium or configured to reproduce one or more processors. As an example, the components may include components such as software components, object-oriented software components, class components, and task components, as well as processes, functions, attributes, procedures, subroutines, segments of a program code, drivers, firmware, microcode, circuitry, data, database, data structures, tables, arrays, and variables.

According to various embodiments, each component (e.g., a module or a program) of the above-described components may include a single or multiple entities. According to various embodiments, one or more components or operations among the above-described components may be omitted or one or more other components or operations may be added. Alternatively or additionally, a plurality of components (e.g., a module or a program) may be integrated into one component. In this case, the integrated component may perform one or more functions of each component of the plurality of components in the manner same as or similar to being performed by the corresponding component of the plurality of components prior to the integration. According to various embodiments, operations performed by modules, programs, or other components may be executed sequentially, parallelly, repeatedly, or heuristically, one or more of the operations may be executed in a different order or omitted, or one or more other operations may be added.

What is claimed is:

1. A mobile device comprising:
a camera module;
a communication module providing a wireless link for communication with a server; and
a processor functionally connected to the camera module and the communication module,
wherein the processor collects video data through the camera module and determines whether to perform an offloading function for analyzing the video data by utilizing computing resources of the server according to a wireless link status of the communication module based on an offloading policy, and
the offloading policy is determined by learning a change in video analysis performance of the mobile device and the server according to a change in the wireless link status.

2. The mobile device of claim 1, wherein the processor learns delay time and per-frame energy consumption required for analysis of the video data as the video analysis performance.

3. The mobile device of claim 2, wherein the processor calculates a time interval from when the analysis of the video data begins to when the analysis of the video data ends, as the delay time.

4. The mobile device of claim 2, wherein the processor calculates the per-frame energy consumption by dividing an energy consumption of the mobile device by a frame rate related to analysis processing of the video data while analyzing the video data.

5. The mobile device of claim 1, wherein the processor determines the offloading policy to minimize per-frame energy consumption while maintaining a delay time for the video analysis that is less than or equal to a specified threshold.

6. The mobile device of claim 1, wherein the processor determines and updates the offloading policy according to a change in the video analysis performance due to a change in the wireless link status using an online learning algorithm.

7. The mobile device of claim 1, wherein, when it is determined that the offloading function is performed, the processor transmits preprocessed video data obtained by reducing the video data to a specified size and normalizing the video data to the server through the communication module, and receives analysis result data for the preprocessed video data from the server.

8. The mobile device of claim 1, wherein, when it is determined that the offloading function is not performed, the processor preprocesses the video data and then performs specified inference in the mobile device.

9. A selective offloading method of a mobile device, the selective offloading method comprising:
checking a wireless link status when video data is collected through a camera module;
performing video analysis on the video data by utilizing computing resources of the mobile device or a server based on an offloading policy according to the wireless link status; and
updating the offloading policy based on a correlation between video analysis performance according to the wireless link status.

10. The selective offloading method of claim 9, wherein the updating includes checking delay time and per-frame energy consumption required for analysis of the video data as the video analysis performance.

11. The selective offloading method of claim 10, wherein the checking of the delay time and per-frame energy consumption includes calculating a time interval from when the analysis of the video data begins to when the analysis of the video data ends, as the delay time.

12. The selective offloading method of claim 10, wherein the checking of the delay time and per-frame energy consumption includes calculating the per-frame energy consumption by dividing an energy consumption of the mobile device by a frame rate related to analysis processing of the video data while analyzing the video data.

13. The selective offloading method of claim 9, wherein the updating includes determining the offloading policy to minimize per-frame energy consumption while maintaining a delay time for the video analysis that is less than or equal to a specified threshold.

14. The selective offloading method of claim 9, wherein the updating includes determining and updating the offloading policy according to a change in the video analysis performance due to a change in the wireless link status using an online learning algorithm.

15. The selective offloading method of claim 9, further comprising:
when it is determined that the offloading function is performed, transmitting preprocessed video data obtained by reducing the video data to a specified size and normalizing the video data to the server; and
receiving analysis result data for the preprocessed video data from the server.

16. The selective offloading method of claim 9, further comprising:
when it is determined that the offloading function is not performed, preprocessing the video data and then performing specified inference in the mobile device.

17. A mobile device comprising:
a memory including at least one instruction; and
a processor functionally connected to the memory,
wherein, when the at least one instruction is executed, the processor is configured to:
check a wireless link status on a communication path with a server performing edge computing-based video analysis when video data is collected;
analyze the video data by selectively utilizing computing resources of the server or the mobile device based on an offloading policy according to the wireless link status; and
update the offloading policy by learning a change in video analysis performance for the video data according to a change in the wireless link status.

18. The mobile device of claim 17, wherein, when the at least one instruction causes is executed, the processor learns delay time and per-frame energy consumption required for analysis of the video data as the video analysis performance.

19. The mobile device of claim 18, wherein, when the at least one instruction is executed, the processor calculates the per-frame energy consumption by dividing the energy consumption of the mobile device by a frame rate related to analysis processing of the video data while analyzing the video data.

20. The mobile device of claim 17, wherein, when the at least one instruction is executed, the processor determines the offloading policy to minimize the per-frame energy consumption while maintaining the delay time for the video analysis that is less than or equal to a specified threshold.
